(19) United States
(12) Patent Application Publication
(10) Pub. No.: US 2025/0048241 A1
(43) Pub. Date: Feb. 6, 2025

(54) NETWORK SLICE BASED USER EQUIPMENT (UE) STEERING IN WIRELESS COMMUNICATION NETWORKS

(71) Applicant: T-MOBILE INNOVATIONS LLC, Overland Park, KS (US)

(72) Inventors: George Jason Schnellbacher, Leawood, KS (US); Zheng Fang, McLean, VA (US)

(21) Appl. No.: 18/362,541

(22) Filed: Jul. 31, 2023

(51) Int. Cl. H04W 48/18; H04W 48/10

(52) U.S. Cl. CPC H04W 48/18; H04W 48/10

(57) ABSTRACT

Various embodiments comprise a wireless communication network to perform slice-based steering for User Equipment (UE). In some examples, a control plane detects an event UE and responsively selects a network slice to support the traffic type for the event UE. The control plane selects a Radio Access Network (RAN) to serve the event UE based on Key Performance Indicators (KPIs) for the RAN and directs the RAN to broadcast a slice Identifier (ID) for the selected slice. The RAN receives the direction from the control plane and responsively broadcasts the slice ID for the event UE. The event UE detects the slice ID broadcast by the RAN, matches the slice ID to a provisioned slice ID, and responsively attaches to the RAN. The event UE wirelessly exchanges user data over the RAN.

### TECHNICAL FIELD

Various embodiments of the present technology relate to User Equipment (UE) steering, and more specifically, to controlling cell selection and mobility based on the traffic profile and slice type for select UE.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Some user devices comprise event user devices. An event device is a type of user device capable of performing a specific service, typically at a specific time. Exemplary event devices include remote controlled devices for teleoperations, live video broadcasting devices, Extended Reality (XR) devices, online gaming devices, and the like. The traffic profiles for event devices often comprise strict bandwidth and latency requirements. The ability of RANs to support the traffic requirements of event devices varies. When a RAN cannot support the traffic requirements of an event device, the user experience is degraded. Unfortunately, wireless communication networks do not efficiently support the traffic requirements of event devices over the RANs. Moreover, event devices do not effectively identify RANs that can support their traffic requirements.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for User Equipment (UE) steering. Some embodiments comprise a method of operating a wireless communication network to perform slice-based steering for UE. The method comprises a control plane detecting an event UE and responsively selecting a network slice to support the traffic type for the event UE. The method further comprises the control plane selecting a Radio Access Network (RAN) to serve the event UE based on one or more Key Performance Indicators (KPIs) for the RAN and directing the RAN to broadcast a slice Identifier (ID) for the selected network slice. The method further comprises the RAN receiving the direction from the control plane and responsively broadcasting the slice ID for the event UE. The method further comprises the event UE detecting the slice ID broadcast by the RAN, matching the slice ID broadcast by the RAN to a provisioned slice ID for the event UE, and in response, wirelessly attaching to the RAN. The method further comprises the event UE wirelessly exchanging user data that comprises the traffic type over the RAN.

Some embodiments comprise a wireless communication network to perform slice-based steering for UE. The wireless communication network comprises a control plane, a RAN, and an event UE. The control plane detects an event UE and responsively selects a network slice to support the traffic type for the event UE. The control plane selects a RAN to serve the event UE based on one or more KPIs for the RAN and directs the RAN to broadcast a slice ID for the selected network slice. The RAN receives the direction from the control plane and responsively broadcasts the slice ID for the event UE. The event UE detects the slice ID broadcast by the RAN, matches the slice ID broadcast by the RAN to a provisioned slice ID for the event UE, and in response, wirelessly attaches to the RAN. The event UE wirelessly exchanges user data that comprises the traffic type over the RAN.

Some embodiments comprise a method of operating a wireless communication network to perform slice-based steering for UE. The method comprises an Access and Mobility Management Function (AMF) detecting an event UE and responsively selecting wireless network slices to support the traffic type for the event UE. The method further comprises the AMF selecting a RAN to serve the event UE based on KPIs for the RAN and directing the RAN to broadcast System Information Blocks (SIBs) that include slice IDs for the selected wireless network slices. The method further comprises the RAN generating SIBs that include the slice IDs and wirelessly broadcasting the SIBs. The method further comprises the event UE wirelessly receiving the SIBs broadcast by the RAN, detecting the slice IDs included in the SIBs, matching the slice IDs detected in the SIBs to provisioned slice IDs for the event UE, and in response, wirelessly attaching to the RAN. The method further comprises the event UE wirelessly exchanging user data that comprises the traffic type with a User Plane Function (UPF) over the RAN.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a data network to perform slice-based steering for an event device.

FIG. 2 illustrates an exemplary operation of the data network to perform slice-based steering for the event device.

FIG. 3 illustrates a wireless communication network to perform slice-based steering for an event User Equipment (UE).

FIG. 4 illustrates an exemplary operation of the wireless communication network to perform slice-based steering for the event UE.

FIG. 5 illustrates an event UE, Radio Access Networks (RANs) and a control plane in the wireless communication network.

FIG. 6 illustrates a Fifth Generation (5G) wireless communication network to perform slice-based steering for a 5G event UE.

FIG. 7 illustrates the 5G event UE in the 5G communication network.

FIG. 8 illustrates a 5G RAN in the 5G wireless communication network.

FIG. 9 illustrates 5G RANs, an Access and Mobility Management Function (AMF), and a Network Exposure Function (NEF) in the 5G wireless communication network.

FIG. 10 illustrates a Network Function Virtualization Infrastructure (NFVI) in the 5G wireless communication network.

FIG. 11 further illustrates the NFVI in the 5G wireless communication network.

FIG. 12 illustrates an exemplary operation of the 5G wireless communication network to perform slice-based steering for the 5G event UE.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

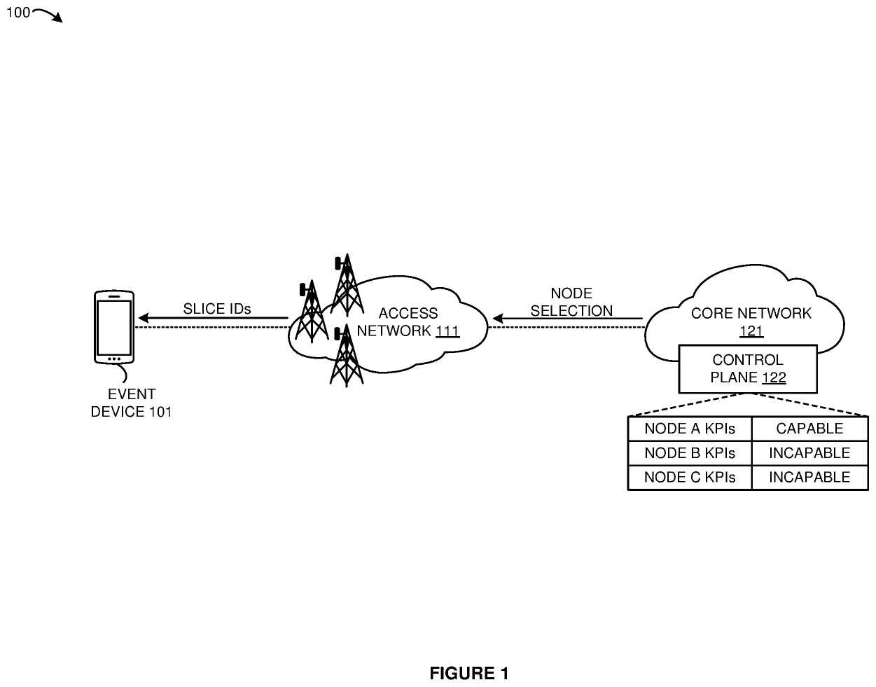

FIG. 1 illustrates data network 100 network to perform slice-based steering for an event device. Data network 100 delivers services like voice calling machine communications, internet-access, media-streaming, or some other wireless communications product to user devices. Data network 100 comprises event device 101, access network 111, and core network 121. Core network 121 comprises control plane 122. In other examples, data network 100 may comprise additional or different elements than those illustrated in FIG. 1.

Various examples of network operation and configuration are described herein. In some examples, control plane 122 detects device 101 is an event device. An event device comprises a device to perform a specific service or a specific service at a specific time. For example, event device 101 may perform live video upload, comprise a remote-control device like a drone, participate in an Extended Reality (XR) session, participate in an online gaming session, or comprise another type of event device. Control plane 122 determines selects a network slice to support the traffic type for event device 101. For example, control plane 122 may determine the traffic type for event device 101 is live video upload and may select a network slice with capabilities to support high bandwidth, low-latency uplink data communications. Control plane 122 hosts a table that associates access node Key Performance Indicators (KPIs) and the node's capability to support the traffic requirements of event device 101 for wireless access nodes in access network 111. As illustrated in FIG. 1, the KPIs for node A indicate node A is capable of supporting the traffic requirements of event device 101 while the KPIs for nodes B and C indicate nodes B and Care incapable of supporting the traffic requirements of event device 101. Control plane 122 selects an access node in access network 111 for event device 101 based on KPIs reported by access network 111. Control plane 122 directs access network 111 to broadcast the slice Identifier (ID) for the selected network slice on the selected access node. Access network 111 broadcasts the slice ID on the selected access node and restricts other access nodes from broadcasting the slice ID to steer event device 101 to the selected node. For example, access network 111 may include the slice ID in System Information Blocks (SIBs) broadcast by the selected node and may restrict other nodes from including the slice ID in their SIBs. Event device 101 detects the slice ID broadcast by the selected access node and compares the detected slice ID to its provisioned slice ID. Event device 101 matches the broadcast slice ID to its provisioned slice ID and responsively attaches to the access node selected by control plane 122. Event device 101 wirelessly exchanges user data that comprises the traffic type over the selected access node in access network 111 with core network 121.

Event device 101 is representative of a wireless user device. Exemplary user devices include phones, computers, vehicles, drones, robots, sensors, and/or other devices with wireless communication capabilities. Access network 111 exchanges wireless signals with event device 101 over radio frequency bands. The radio frequency bands use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). Access network 111 is connected to core network 121 over backhaul data links. Access network 111 exchanges network signaling and user data with network elements in core network 121. Access network 111 may comprise wireless access points, Radio Access Networks (RANs), internet backbone providers, edge computing systems, or other types of wireless/wireline access systems to provide wireless links to event device 101, the backhaul links, and edge computing services between event device 101 and core network 121.

Access network 111 comprises wireless access nodes to serve event device 101. The access nodes serve geographic regions referred to as sectors. The access nodes may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to core network 121. The CUs handle higher wireless network layers like the Radio Resource Control (RRC), Service Data Adaption Protocol (SDAP), and Packet Data Convergence Protocol (PDCP). The CUs are coupled to network functions in core network 121.

Core network 121 is representative of computing systems that provide wireless data services to event device 101 over access network 111. Exemplary computing systems comprise data centers, server farms, cloud computing networks, hybrid cloud networks, and the like. The computing systems of core network 121 store and execute the network functions to form control plane 122 to provide wireless data services to event device 101 over access network 111. Control plane 122 may comprise network functions like Access and Mobility Management Function (AMF) and Session Management Function (SMF). Core network 121 may comprise a Fifth Generation Core (5GC) architecture and/or an Evolved Packet Core (EPC) architecture.

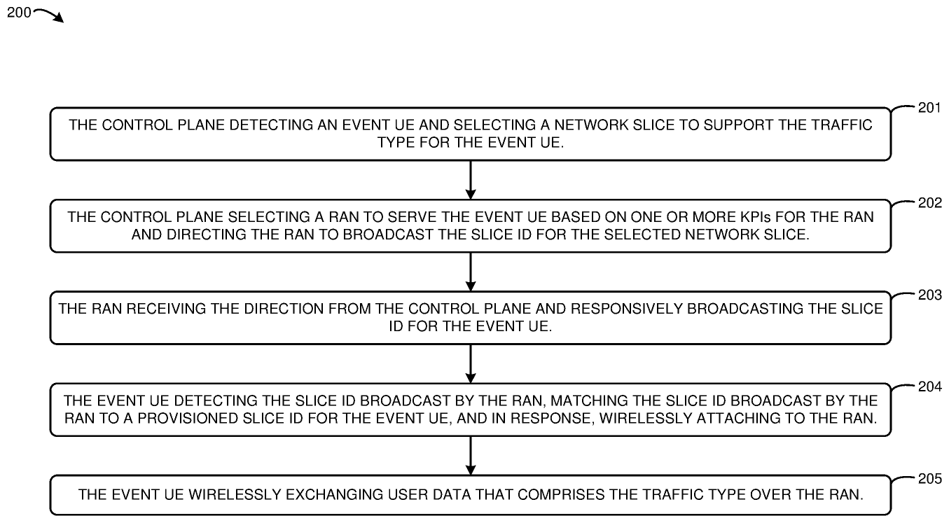

FIG. 2 illustrates process 200. Process 200 comprises an exemplary operation of data network 100 to perform slice-based steering for an event device. The operation may vary in other examples. The operations of process 200 comprise the control plane detecting an event UE and selecting a network slice to support the traffic type for the event UE (step 201). The operations further comprise the control plane selecting a RAN to serve the event UE based on one or more KPIs for the RAN and directing the RAN to broadcast the slice ID for the selected network slice (step 202). The operations further comprise the RAN receiving the direction from the control plane and responsively broadcasting the slice ID for the event UE (step 203). The operations further comprise the event UE detecting the slice ID broadcast by the RAN, matching the slice ID broadcast by the RAN to a provisioned slice ID for the event UE, and in response, wirelessly attaching to the RAN (step 204). The operations further comprise the event UE wirelessly exchanging user data that comprises the traffic type over the RAN (step 205).

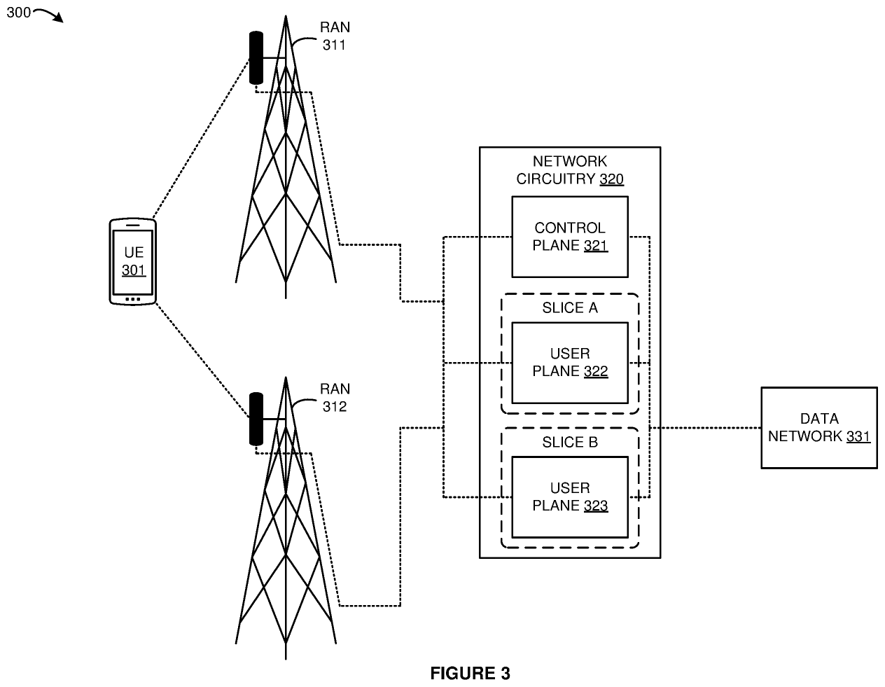

FIG. 3 illustrates wireless communication network 300 network to perform slice-based steering for an event User Equipment (UE). Wireless communication network 300 is an example of data network 100, however network 100 may differ. Wireless communication network 300 comprises UE 301, RANs 311 and 312, network circuitry 320, and data network 331. Network circuitry 320 comprises control plane 321, user plane 322, and user plane 323. User plane 322 forms slice A and user plane 323 forms slice B. UE 301 comprises an event device. In other examples, wireless network 300 may comprise additional or different elements than those illustrated in FIG. 3.

In some examples, control plane 321 receives an event UE request generated by UE 301 and responsively determines UE 301 is an event UE. Control plane 321 selects a network slice to support the traffic requirements of UE 301. As illustrated in FIG. 3, slice A comprise user plane 322 and slice B comprises user plane 323. Each slice can support different types of service for UE 301. For example, user plane 322 in slice A may comprise low-latency, command-and-control functionality while user plane 323 in slice B may comprise high downlink throughput functionality.

Once the slice(s) is selected, control plane 321 determines which of RANs 311 and 312 is best suited to support the selected slice. Control plane 321 accesses KPIs for RANs 311 and 312. Exemplary KPIs include served slice IDs, Radio Access Technology (RAT) type, frequency/band, bandwidth, Physical Cell Identifier (PCI), Fifth Generation Quality-of-Service Identifier (5QI), maximum uplink/downlink bitrate, cell loading, and the like. Control plane 321 compares the RAN KPIs to the requirements of the slice to select one of RANs 311 or 312 for UE 301. Control plane 321 directs the selected one of RANs 311 and 312 to broadcast the slice ID for the selected network slice and restricts the non-selected one of RANs 311 and 312 from broadcasting the slice ID for the selected network slice. UE 301 wirelessly receives SIBs broadcast by RANs 311 and 312 and identifies the slice IDs included in the SIBs. UE 301 attaches to the one of RANs 311 and 312 that broadcast the selected slice ID. For example, RAN 311 may broadcast SIBs with the slice ID provisioned to UE 301 while RAN 312 may broadcast SIBs with other slice IDs and UE 301 may responsively attach to RAN 311 based on the slice ID broadcast by RAN 311 matching its provisioned slice ID. UE 301 exchanges user data with either user plane 322 or 323 over the one of RANs 311 or 312 that UE 301 attached to.

Advantageously, wireless communication network 300 efficiently selects optimal RANs to support the traffic requirements of event UE and steers event UE to the selected RANs. Moreover, event UE 301 effectively identifies the selected RAN based on the slice IDs broadcast by the selected RAN.

UE 301, RAN 311, and RAN 312 communicate over links using wireless technologies like 5GNR, LTE, LP-WAN, WIFI, Bluetooth, and/or some other type of wireless networking protocol. The wireless technologies use electromagnetic frequencies in the low-band, mid-band, high-band, or some other portion of the electromagnetic spectrum. RAN 311, network circuitry 320, and data network 331 communicate over various links that use metallic links, glass fibers, radio channels, or some other communication media. The links use Fifth Generation Core (5GC), IEEE 802.3 (ENET), Time Division Multiplex (TDM), Data Over Cable System Interface Specification (DOCSIS), Internet Protocol (IP), General Packet Radio Service Transfer Protocol (GTP), 5GNR, LTE, WIFI, virtual switching, inter-processor communication, bus interfaces, and/or some other data communication protocols.

UE 301 may comprise a phone, vehicle, computer, sensor, drone, robot, or another type of data appliance with wireless communication circuitry. Although RANs 311 and 312 are illustrated as towers, RANs 311 and 312 may comprise other types of mounting structures (e.g., buildings), or no mounting structure at all. RANs 311 and 312 comprise Fifth Generation (5G) RANS, LTE RANs, gNodeBs, eNodeBs, NB-IoT access nodes, LP-WAN base stations, wireless relays, WIFI hotspots, Bluetooth access nodes, and/or other types of wireless network transceivers. UE 301, RAN 311, and RAN 312 comprise antennas, amplifiers, filters, modulation, analog/digital interfaces, microprocessors, software, memories, transceivers, bus circuitry, and the like. Control plane 321 comprises network functions like AMF, SMF, and the like. User planes 322 and 323 comprise network functions like User Plane Function (UPF) and the like.

UE 301, RANs 311 and 312, network circuitry 320, and data network 331 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, Solid State Drives (SSD), Non-Volatile Memory Express (NVMe) SSDs, Hard Disk Drives (HDDs), and/or the like. The memories store software like operating systems, user applications, radio applications, network functions, and multimedia functions. The microprocessors retrieve the software from the memories and execute the software to drive the operation of wireless communication network 300 as described herein.

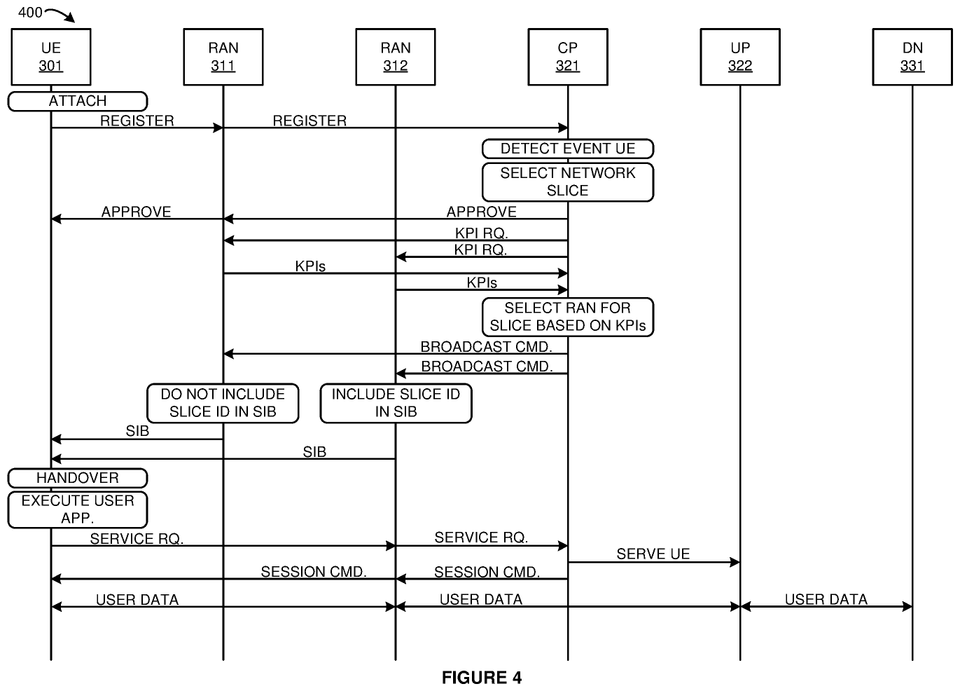

FIG. 4 illustrates process 400. Process 400 comprises an exemplary operation of wireless communication network 300 to perform slice-based steering for event UE 301. In operation, UE 301 attaches to RAN 311 and transfers a registration request to control plane (CP) 321 over RAN 311. The registration request indicates UE 301 comprises an event UE and a slice request for slice A. Control plane 321 registers UE 301 for wireless communication service on network 100. Control plane 321 detects UE 301 is an event UE and directs user plane 322 to serve UE 301 based on the request. For example, UE 301 may transfer an Application Programming Interface (API) call to a privileged API hosted by control plane 321 that authorizes event UE for privileged service and the API may confirm UE 301 is an event UE. Control plane 321 transfers a registration approval message to UE 301 over RAN 311. The approval message includes the slice ID for slice A to provision UE 301 with its selected slice ID.

Control plane 321 transfers KPI requests to RANs 311 and 312. RANs 311 and 312 report their KPIs to control plane 321. Control plane 321 correlates the reported KPIs to a capability to support traffic on slice A. In this example, control plane 321 selects RAN 312 for UE 301 based on its KPIs indicating RAN 312 is better able to support traffic on slice A. For example, control plane 321 may enter the KPIs and slice type into a data structure that outputs a suitability score for RANs 311 and 312 and control plane 321 may select one of RANs 311 and 312 based on the output from the data structure. The KPI score may be based on metrics like maximum available uplink/downlink bitrate, RAN capacity, RAN loading, and the like. Control plane 321 may compare the suitability score to a performance threshold to determine that the RAN exceeds the bitrate requirements, latency requirements, capacity requirements, and the like for the selected network slice.

Control plane 321 transfers a broadcast command (CMD.) to RAN 311 and RAN 312. The broadcast command to RAN 311 directs RAN 311 to exclude the slice ID for slice A in its SIBs and the broadcast command to RAN 312 directs RAN 312 to include the slice ID for slice A in its SIBs. RANs 311 and 312 receive their broadcast commands. RAN 311 generates and broadcasts SIBs that do not include the slice ID for slice A. RAN 312 generates and broadcast SIBs that only include the slice ID for slice A. UE 301 wirelessly receives the SIBs broadcast by RANs 311 and 312. UE 301 compares the slice IDs from the SIBs to its provisioned slice ID for slice A received during registration and decides to attach to RAN 312 based on the comparison. In response, UE 301 hands over to RAN 312.

UE 301 executes a user application to perform the event service. Exemplary event services include live video broadcasting, teleoperation, XR sessions, online gaming sessions, and the like. UE 301 transfers a service request (RQ.) for the event service to control plane 321 over RAN 312 to initiate the session. Control plane 321 directs user plane (UP) 322 to serve UE 301 and transfers a session command to UE 301 over RAN 312 to begin the requested session. UE 301 exchanges user data for the session with RAN 312. RAN 312 exchanges the user data with user plane 322. User plane 322 exchanges the user data with data network (DN) 331.

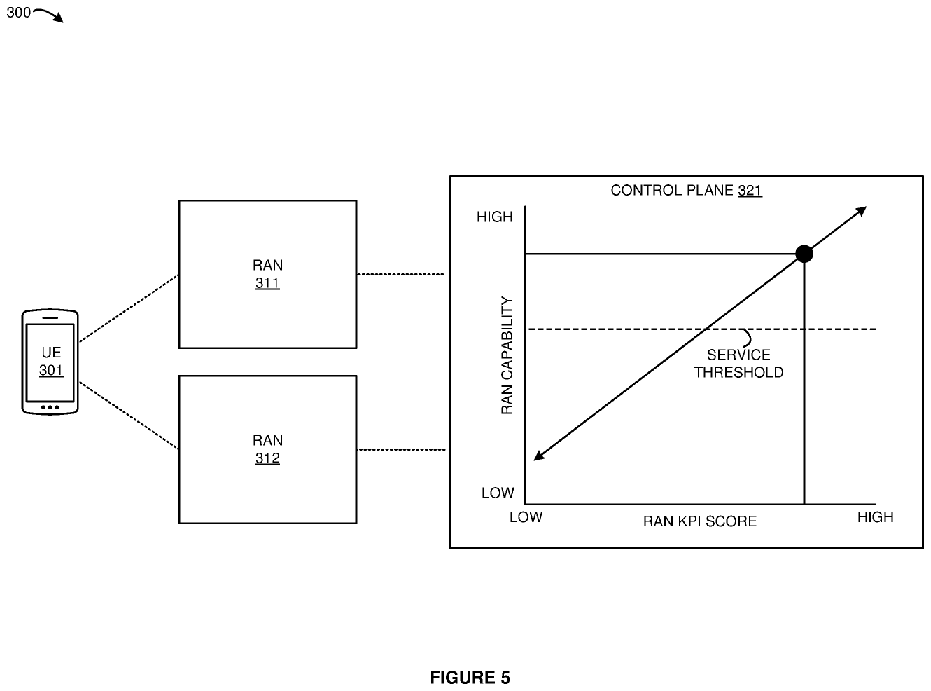

FIG. 5 further illustrates UE 301, RANs 311 and 312, and control plane 321 in wireless communication network 300. Control plane 321 hosts a data structure that implements the graph illustrated in FIG. 5. The x-axis of the graph comprises RAN KPI score in the range low to high. The y-axis of the graph comprises RAN capability in the range low to high. It should be appreciated that the ranges are exemplary and numeric values could be used in other examples. RAN KPI score comprises an aggregate numeric representation of the various KPIs reported by a RAN. For example, control plane 321 may retrieve KPIs from RAN 311 and calculate a normalized weighted sum based on the retrieved KPIs to generate the KPI score. RAN capability is representative of the RAN's capability to support a specific network slice or set of network slices. For example, RAN capability may be expressed as RAN capacity in units of bits-per-second (BPS). As shown in FIG. 5, a RAN KPI score correlates to a RAN capability. As RAN KPI score increases, the RAN capability to support the network slice also increases. The service threshold is representative of a minimum RAN capability to support the network slice assigned to UE 301.

In some examples, RANs 311 and 312 report KPIs including served slice IDs, RAT type, frequency/band, bandwidth, PCI, 5QI, maximum uplink/downlink bitrate, and cell loading. RANs 311 and 312 may report their KPIs periodically or in response to receiving a request from control plane 321. Control plane 321 weights and sums the KPI values to generate KPI scores for RAN 311 and RAN 312. Control plane 321 inputs the KPI scores into the data structure to determine a RAN capability for RAN 311 and a RAN capability for RAN 312. Control plane 321 applies the service threshold to the RAN capability for RAN 311 and the RAN capability for RAN 312. If the RAN capability for one of RAN 311 or RAN 312 does not exceed the service threshold while the RAN capability for the other one of RAN 311 or RAN 312 exceeds the service threshold, control plane 321 selects the exceeding one to steer UE 301 to. If the RAN capability for both RAN 311 and RAN 312 exceed the service threshold, control plane 321 compares the RAN capabilities and selects the RAN with the higher RAN capability to steer UE 301 to. If neither RAN exceeds the service threshold, control plane 321 may notify UE 301 or attempt to identify another RAN to serve UE 301.

In some examples, after UE 301 attaches to the selected RAN and initiates the event session, the RAN's ability to support the traffic requirements of the event session may deteriorate. For example, if UE 301 begins the event session on RAN 311, RAN loading may increase which diminishes RAN 311's ability to support the traffic requirements of UE 301. To detect when RANs can no longer maintain the traffic requirements, the serving RAN tracks RAN capacity based on average spectrum efficiency and channel bandwidth. For example, RAN 311 may multiply its measured spectral efficiency with its channel bandwidth to determine its capacity. Control plane 321 compares the reported capacity to the service threshold (e.g., bitrate requirement for event UE 301). When the capacity of the serving RAN falls below the service threshold, control plane 321 selects another RAN (e.g., RAN 312) to serve event UE 301 based KPI score for the other RAN. Control plane 322 directs the other RAN to broadcast SIBs that include the slice IDs for event UE 301 and directs the serving RAN to remove slice IDs for UE 301 from its SIBs. UE 301 detects the changed SIBs and responsively hands over to other RAN. Alternatively, control plane 311 or the serving RAN may transfer a handover command to UE 301 directing UE 301 to handover to the other RAN.

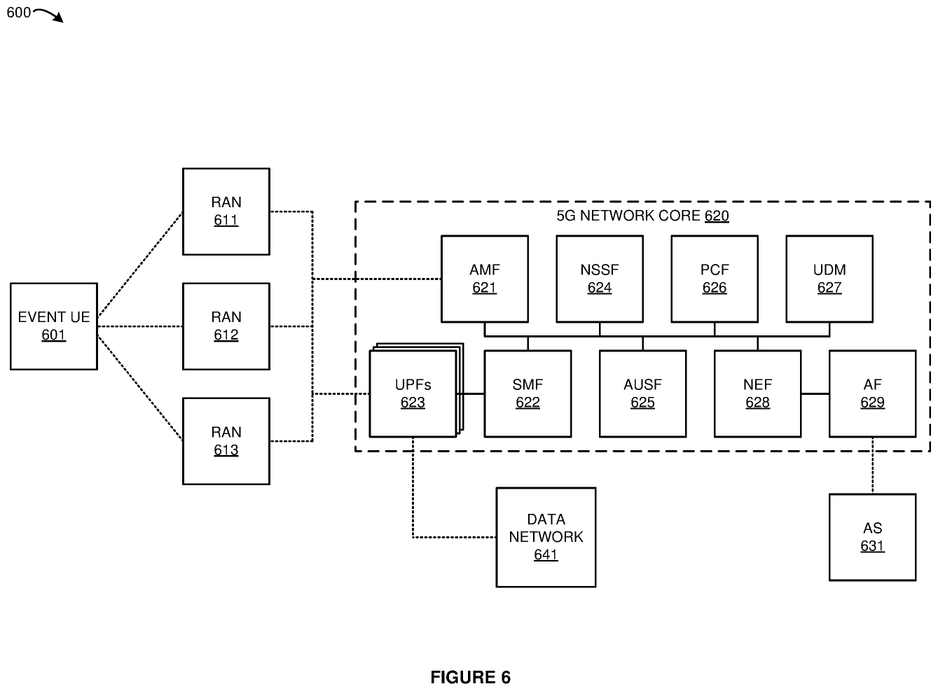

FIG. 6 illustrates 5G communication network 600 to perform slice-based steering for a 5G event UE. Communication network 600 comprises 5G event UE 601, RANs 611-613, 5G network core 620, Application Server (AS) 631, and data network 641. 5G core network 620 comprises Access and Mobility Management Function (AMF) 621, Session Management Function (SMF) 622, User Plane Functions (UPFs) 623, Network Slice Selection Function (NSSF) 624, Authentication Server Function (AUSF) 625, Policy Control Function (PCF) 626, Unified Data Management (UDM) 627, Network Exposure Function (NEF) 628, and Application Function (AF) 629. Other network functions and network elements like Network Repository Function (NRF), Session Communication Proxy (SCP), and Unified Data Registry (UDR) are typically present in 5G network core 620 but are omitted for clarity. In other examples, 5G communication network 600 may comprise different or additional elements than those illustrated in FIG. 6.

In some examples, event UE 601 wirelessly attaches to RAN 611. UE 601 exchanges attachment signaling with RAN 611 to establish a signaling radio bearer with 5G network applications hosted by RAN 611. UE 601 transfers a registration request over the default signaling bearer to RAN 611. The registration request includes information like a registration type, UE capabilities, an event UE indication, requested slice types, Protocol Data Unit (PDU) session requests, and the like. RAN 611 forwards the registration request for UE 601 to AMF 621. In response to the registration request, AMF 621 transfers an identity request to UE 601 over RAN 611. UE 601 indicates its identity to RAN 611 over the default signaling radio bearer. RAN 611 forwards the identity indication to AMF 621. Exemplary identity indications include Subscriber Concealed Identifier (SUCI) and Subscriber Permanent Identifier (SUCI). AMF 621 selects AUSF 625 to authenticate the identity of UE 601 and transfers an authentication request to AUSF 625. AUSF 625 retrieves authentication data from UDM 627. AUSF 625 transfers the authentication type and an authentication challenge to AMF 621. AMF 621 indicates the authentication type and transfers the authentication challenge to UE 601 over RAN 611. UE 601 uses its key to generate an authentication response based on the indicated authentication type and transfers the response to AMF 621 over RAN 611. AMF 621 compares the authentication response to an expected result and authenticates the identity of UE 601 when the response and expected result match.

Responsive to the authentication, AMF 621 selects UDM 627 to generate UE context for UE 601. AMF 621 retrieves Quality-of-Service (QOS) metrics, allowed slice IDs, service attributes, and the like from UDM 627. AMF 621 selects PCF 625 to create a network policy association for UE 601. PCF 625 transfers network policy information for UE 601 to AMF 621 and registers for event reporting from AFM 621 like registration state change events. AMF 621 detects UE 601 is an event UE based on the information included in the registration request. In other examples, AMF 621 may detect UE 601 is an event UE based on an indication received from a third-party. For example, AS 631 may transfer an event UE indication for UE 601 to NEF 628 over AF 629 and NEF 628 may expose the indication to AMF 621. Returning to the example, AMF 621 interfaces with NSSF 624 to select network slices for UE 601. AMF 621 indicates the network slices requested by UE 601 in the registration request to NSSF 624. NSSF 624 selects a set of network slices that correspond to the request from UE 601 and returns slice IDs for the selected slices to AMF 621. In this example, each network slice corresponds to one of UPFs 623, however the network slices may comprise additional network functions and/or multiple ones of UPFs 623.

AMF 621 selects SMF 622 to serve UE 601 based on the slice IDs, QoS metrics, requested PDU sessions, service attributes, and/or other data retrieved UDM 627 or received in the registration request from UE 601. SMF 622 selects ones of UPFs 623 that correspond to the slice IDs to serve UE 601. SMF 622 indicates the network addresses for selected ones of UPFs 623 to AMF 621. AMF 621 generates UE context comprising the information retrieved from UDM 627, the policy information provided by PCF 626, the slice IDs returned by NSSF 624, and the network addresses for the UPFs selected by SMF 622. AMF 621 transfers the UE context for UE 601 to RAN 611. RAN 611 wirelessly transfers the UE context to UE 601 over the default radio signaling bearer. UE 601 stores the UE context in memory.

In response to determining UE 601 is an event UE, AMF 621 transfers KPI requests for served slice IDs, RAT type, frequency/band, bandwidth, PCI, 5QI data, maximum uplink/downlink bitrate, and cell loading data to RANs 611-613. RANs 611-613 return the requested KPI information to AMF 621. AMF 621 dynamically sorts RANs 611-613 based on the reported KPIs to determine the optimal one of RANs 611-613 to support the set of network slices assigned to UE 601. For example, AMF 621 may host a data structure that implements the graph illustrated in FIG. 5 to correlate KPI scores for RANs 611-613 to RAN capabilities. In some examples, AMF 621 hosts a machine learning algorithm trained select RANs best suited to serve the slices assigned to UE 601. For example, AMF 621 may provide the KPIs and slice IDs to the machine learning model and the model may output a RAN selection. Exemplary machine learning algorithms include artificial neural networks, nearest neighbor methods, gradient-boosted trees, ensemble random forests, support vector machines, naïve Bayes methods, and linear regressions.

AMF 621 selects one of RANs 611-613 based on its capability to support the network slices for UE 601. AMF 621 directs the selected one of RAN 611-613 to broadcast SIBs that include the slice IDs provisioned to UE 601. AMF 621 directs the non-selected ones RANs 611-613 exclude one or more of the slice IDs from their SIBs. The selected one of RANs 611-613 generates SIBs and includes all of the slice IDs for UE 601 in the SIBs. The non-selected ones of RANs 611-613 generate SIBs that do not include all of the slice IDs for UE 601.

UE 601 wirelessly receives the SIBs broadcast by RANs 611-613 and reads the slice IDs included in the SIBs. UE 601 compares the slice IDs from the SIBs to its slice IDs provisioned during network registration. UE 601 determines that the SIBs broadcast by the selected one of RANs 611-613 include all of the slice IDs provisioned to UE 601 and that the SIBs broadcast by the non-selected ones of RANs 611-613 do not include all of the slice IDs provisioned to UE 601. In response UE 601 hands over to the selected one of RANs 612-613 or remains attached to RAN 611 when RAN 611 is the selected RAN.

UE 601 uses the UE context to initiate a data session for its event service. For example, if the event service is an XR session, UE 601 may use the UE context to begin an XR session with other UE over the selected RAN and the selected ones of UPFs 623. UE 601 generates uplink user data for the event service and wirelessly transfers the uplink data to the selected RAN. The selected RAN transfers the uplink user data to UPFs 623. In particular, the selected RAN transfers the uplink data to the ones of UPFs 623 the compose the network slices assigned to UE 601. UPFs 623 transfer the uplink data to data network 641. Data network 641 generates downlink data for the event service and transfers the downlink data to UPFs 623. UPFs 623 transfer the downlink data to the selected RAN. The selected RAN wirelessly transfers the downlink data to UE 601.

In some examples, AMF 621 selects RANs based on the subscriber profile for UE 601 stored by UDM 627. In these cases, the subscriber profile stored by UDM 627 associates the International Mobile Subscriber Identity (IMSI) of UE 601 with one of RANs 611-613. This association overrides the network layer management policy for UE 601 that would otherwise govern mobility and RAN selection for UE 601. During registration when AMF 621 retrieves the service metrics from UDM 627, UDM 627 identifies the association and indicates the preferred RAN for UE 601 to AMF 621. AMF 621 includes the cell ID for the preferred RAN in the UE context and transfers the context to UE 601. UE 601 then attaches to one of RANs 611-613 based on the cell ID included in the UE context and exchanges user data for its event service over that RAN as described above.

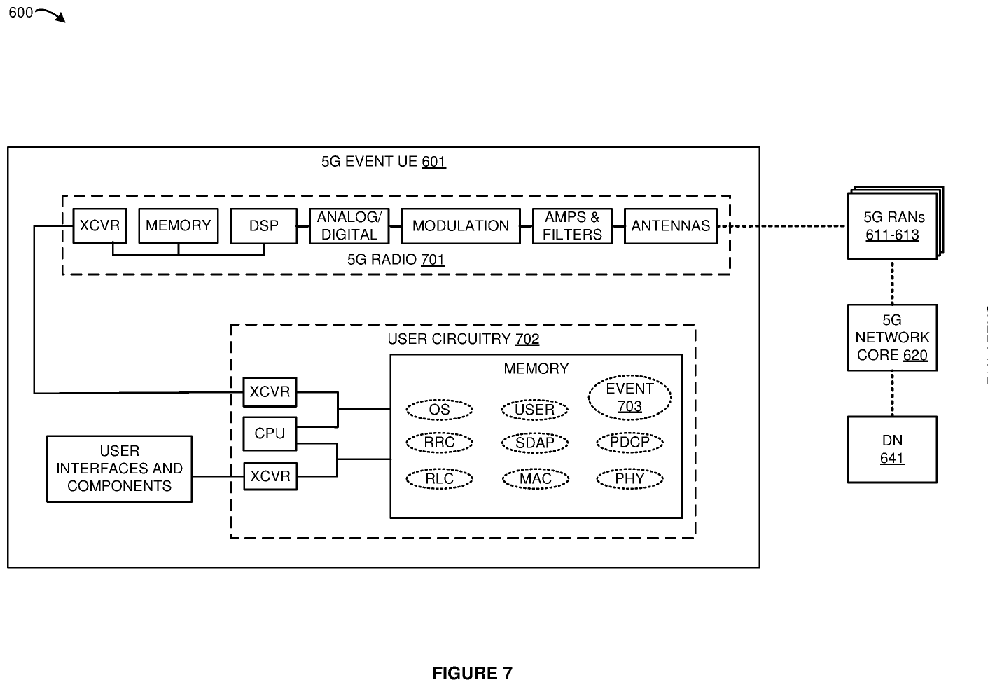

FIG. 7 illustrates 5G event UE 601 in 5G communication network 600. UE 601 comprises an example of event device 101 illustrated in FIG. 1 and UE 301 illustrated in FIG. 3, however event device 101 and UE 301 may differ. UE 601 comprises 5G radio 701 and user circuitry 702. Radio 701 comprises antennas, amplifiers, filters, modulation, analog-to-digital interfaces, Digital Signal Processers (DSP), memory, and transceivers (XCVRs) that are coupled over bus circuitry. User circuitry 702 comprises memory, CPU, user interfaces and components, and transceivers that are coupled over bus circuitry. The memory in user circuitry 702 stores an operating system (OS), user applications (USER), event application (EVENT) 703, and 5GNR network applications for Physical Layer (PHY), Media Access Control (MAC), Radio Link Control (RLC), Packet Data Convergence Protocol (PDCP), Service Data Adaptation Protocol (SDAP), and Radio Resource Control (RRC). The antenna in radio 701 is wirelessly coupled to 5G RAN 611 over 5GNR links. In other examples, the antenna in radio 701 may be wirelessly coupled to 5G RAN 612 or 5G RAN 613 over a 5GNR link. A transceiver in radio 701 is coupled to a transceiver in user circuitry 702. A transceiver in user circuitry 702 is typically coupled to the user interfaces and components like displays, controllers, and memory.

In radio 701, the antennas receive wireless signals from 5G RAN 611 that transport downlink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequency. The analog/digital interfaces convert the demodulated analog signals into digital signals for the DSPs. The DSPs transfer corresponding 5GNR symbols to user circuitry 702 over the transceivers. In user circuitry 702, the CPU executes the network applications to process the 5GNR symbols and recover the downlink 5GNR signaling and data. The 5GNR network applications receive new uplink signaling and data from the user applications. The network applications process the uplink user signaling and the downlink 5GNR signaling to generate new downlink user signaling and new uplink 5GNR signaling. The network applications transfer the new downlink user signaling and data to the user applications. The 5GNR network applications process the new uplink 5GNR signaling and user data to generate corresponding uplink 5GNR symbols that carry the uplink 5GNR signaling and data.

In radio 701, the DSP processes the uplink 5GNR symbols to generate corresponding digital signals for the analog-to-digital interfaces. The analog-to-digital interfaces convert the digital uplink signals into analog uplink signals for modulation. Modulation up-converts the uplink analog signals to their carrier frequency. The amplifiers boost the modulated uplink signals for the filters which attenuate unwanted out-of-band energy. The filters transfer the filtered uplink signals through duplexers to the antennas. The electrical uplink signals drive the antennas to emit corresponding wireless 5GNR signals to 5G RAN 611 that transport the uplink 5GNR signaling and data.

RRC functions comprise authentication, security, handover control, status reporting, QoS, network broadcasts and pages, and network selection. SDAP functions comprise QoS marking and flow control. PDCP functions comprise security ciphering, header compression and decompression, sequence numbering and re-sequencing, de-duplication. RLC functions comprise Automatic Repeat Request (ARQ), sequence numbering and resequencing, segmentation and resegmentation. MAC functions comprise buffer status, power control, channel quality, Hybrid ARQ (HARQ), user identification, random access, user scheduling, and QoS. PHY functions comprise packet formation/deformation, windowing/de-windowing, guard-insertion/guard-deletion, parsing/de-parsing, control insertion/removal, interleaving/de-interleaving. Forward Error Correction (FEC) encoding/decoding, channel coding/decoding, channel estimation/equalization, and rate matching/de-matching, scrambling/descrambling, modulation mapping/de-mapping, layer mapping/de-mapping, precoding, Resource Element (RE) mapping/de-mapping, Fast Fourier Transforms (FFTs)/Inverse FFTs (IFFTs), and Discrete Fourier Transforms (DFTs)/Inverse DFTs (IDFTs). Event application 703 functions include network notification of event UE status and privileged API accessing.

In some examples, event application 703 notifies core network 620 of UE 601's event capability. Event application 703 may include an event indication in the registration signaling received by AMF 621 that triggers event UE treatment by AMF 621 for UE 601. Event application 703 may indicate the event status of UE 601 by transferring an API call to a privileged API in network core 620 only accessible by event devices. For example, AMF 621 may host an API only accessible by event UE like UE 601. During registration, event application 703 may transfer an API call to the API hosted by AMF 621 to indicate the event status of UE 601. In other examples, UE 601 may lack event application 703 and instead rely on third party notification via AS 631 to notify AMF 621 of the event status of UE 601.

In some examples, the RRC in UE 601 controls the lower layer network applications to receive and process SIBs broadcast by RANs 611-613. The RRC in UE 601 reads the slice IDs included in the SIBs broadcast by RANs 611-613 and compares the slice IDs from the SIBs to the slice IDs provisioned to UE 601 during registration. The RRC controls UE 601 to prefer to attach to the RAN which broadcast SIBs that include all of the slice IDs provisioned to UE 601. The RRC controls UE 601 to avoid attaching to RANs which do not include all of the slice IDs provisioned to UE 601 in their SIBs. For example, AMF 621 may provision UE 601 with a network slice comprising slice ID 3000 in the UE context. Subsequently, UE 601 receives SIBs broadcast by RANs 611-613. In this example, the SIBs received from RAN 611 include slice IDs 2000 and 4000, the SIBs received from RAN 612 include slice IDs 2000, 3000, and 4000, and the SIBs received from RAN 613 include slice ID 2000 and 4000. Since the SIBs from RAN 611 and RAN 613 do not include slice ID 3000 while the SIBs from RAN 612 include slice ID 3000, the RRC drives UE 601 to attach to RAN 612.

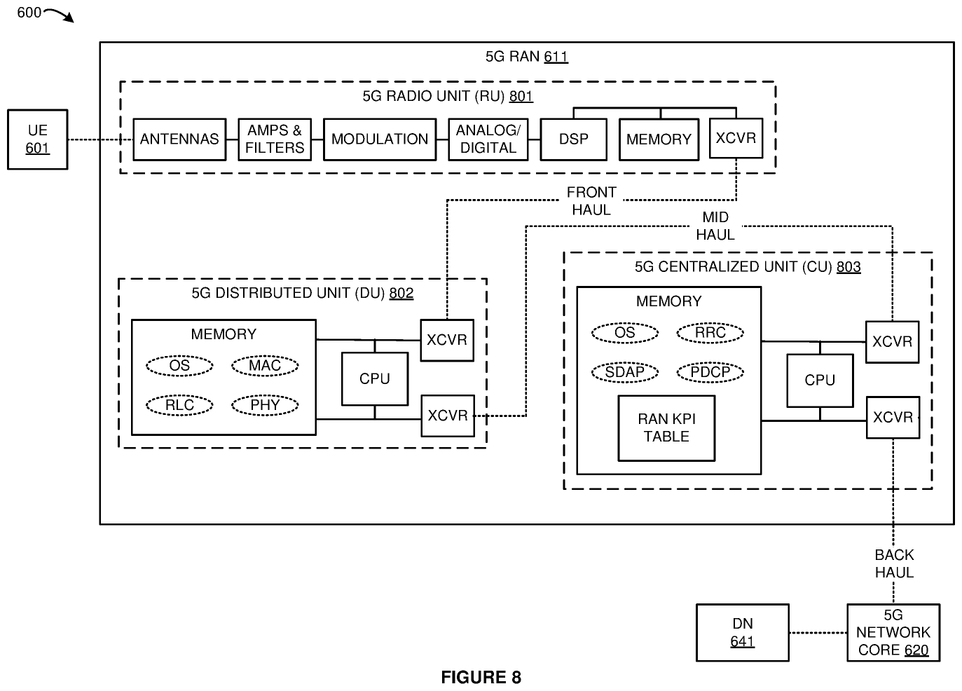

FIG. 8 illustrates 5G RAN 611 in 5G communication network 600. 5G RAN 611 comprises 5G Radio Unit (RU) 801, 5G Distributed Unit (DU) 802, and 5G Centralized Unit (CU) 803. RAN 611 comprises an example of access network 111 illustrated in FIG. 1 and RANs 311 and 312 illustrated in FIG. 3, however access network 111, RAN 311, and RAN 312 may differ. RANs 612 and 613 comprise a similar architecture and operation to RAN 611.

RU 801 comprises antennas, amplifiers, filters, modulation, analog-to-digital interfaces, DSP, memory, and transceivers (XCVRs) that are coupled over bus circuitry. UE 601 is wirelessly coupled to the antennas in RU 801 over 5GNR links. Transceivers in 5G RU 801 are coupled to transceivers in 5G DU 802 over fronthaul links like enhanced Common Public Radio Interface (eCPRI). The DSPs in RU 801 executes their operating systems and radio applications to exchange 5GNR signals with UE 601 and to exchange 5GNR data with DU 802.

For the uplink, the antennas receive wireless signals from UE 601 that transport uplink 5GNR signaling and data. The antennas transfer corresponding electrical signals through duplexers to the amplifiers. The amplifiers boost the received signals for filters which attenuate unwanted energy. Demodulators down-convert the amplified signals from their carrier frequencies. The analog/digital interfaces convert the demodulated analog signals into digital signals for the DSPs. The DSPs transfer corresponding 5GNR symbols to DU 802 over the transceivers.

For the downlink, the DSPs receive downlink 5GNR symbols from DU 802. The DSPs process the downlink 5GNR symbols to generate corresponding digital signals for the analog-to-digital interfaces. The analog-to-digital interfaces convert the digital signals into analog signals for modulation. Modulation up-converts the analog signals to their carrier frequencies. The amplifiers boost the modulated signals for the filters which attenuate unwanted out-of-band energy. The filters transfer the filtered electrical signals through duplexers to the antennas. The filtered electrical signals drive the antennas to emit corresponding wireless signals to UE 601 that transport the downlink 5GNR signaling and data.

DU 802 comprises memory, CPU, and transceivers that are coupled over bus circuitry. The memory in 5G DU 802 stores operating systems and 5GNR network applications like PHY, MAC, and RLC. CU 803 comprises memory, CPU, and transceivers that are coupled over bus circuitry. The memory in CU 803 stores an operating system, 5GNR network applications like PDCP, SDAP, and RRC, and a RAN KPI table. Transceivers in 5G DU 802 are coupled to transceivers in RU 801 over front-haul links. Transceivers in DU 802 are coupled to transceivers in CU 803 over mid-haul links. A transceiver in CU 803 is coupled to network core 620 over backhaul links.

RLC functions comprise ARQ, sequence numbering and resequencing, segmentation and resegmentation. MAC functions comprise buffer status, power control, channel quality, HARQ, user identification, random access, user scheduling, and QoS. PHY functions comprise packet formation/deformation, guard-insertion/guard-deletion, parsing/de-parsing, control insertion/removal, interleaving/de-interleaving, FEC encoding/decoding, channel coding/decoding, channel estimation/equalization, and rate matching/de-matching, scrambling/descrambling, modulation mapping/de-mapping, layer mapping/de-mapping, precoding, RE mapping/de-mapping, FFTs/IFFTs, and DFTs/IDFTs. PDCP functions include security ciphering, header compression and decompression, sequence numbering and re-sequencing, de-duplication. SDAP functions include QoS marking and flow control. RRC functions include authentication, security, handover control, status reporting, QoS, network broadcasts and pages, and network selection.

In some examples, the RRC in CU 803 tracks KPIs for RAN 611 that characterize RAN 611's ability to serve different traffic types that correspond to the different network slices in 5G core 620. For example, the RRC may track metrics served bands/frequencies, bandwidth, PCI, 5GI, uplink bitrate, downlink bitrate, cell loading, and the like. The RRC may update the KPI table using the tracked metrics to maintain a near real time performance characterization of RAN 611. The RRC in RAN 611 provides the KPI table or specific metrics in the KPI table to AMF 621. The RRC may provide the metrics to AMF 621 periodically, semi-periodically, randomly, or in response to receive a request from AMF 621. AMF 621 may then use the KPIs tracked by the RRC to decide where to steer UE 601 for cell selection and mobility control.

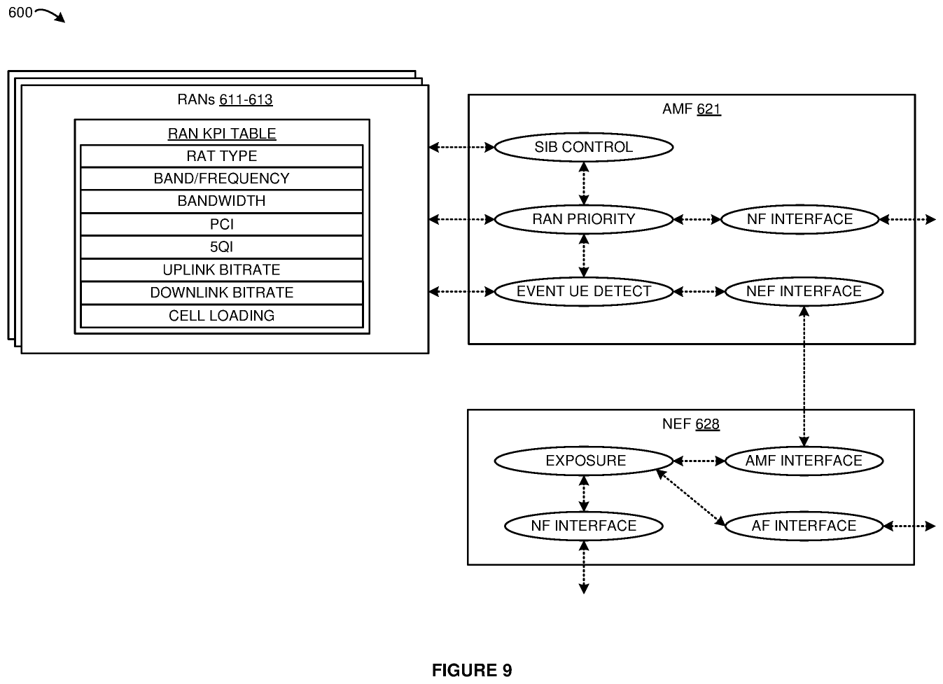

FIG. 9 illustrates RANs 611-613, AMF 621, and NEF 628 in 5G wireless communication network 600. RANs 611-613 each host a RAN KPI table. The RAN KPI table tracks RAT type, band/frequency, bandwidth, PCI, 5QI, uplink bitrate, downlink bitrate, and cell loading. The KPI metrics characterize each of RANs 611-613 ability to serve different traffic types, slice types, device types, and the like. AMF 621 comprises modules for SIB control, RAN prioritization, event UE detection, network function (NF) interfacing, and NEF interfacing. The SIB control module interfaces with RANS 611-613 to control what slice IDs RANs 611-613 broadcast in their SIBs. The RAN prioritization module classifies RANs 611-613 by their KPIs to decide which RAN is most suitable to support a traffic/slice type for UE 601. The event UE detection module detects when event UEs attach to network core 620. NEF 628 comprises modules for event exposure, network function interfacing. AMF interfacing, and AF interfacing. The interfacing modules allow AMF 621 and NEF 628 to exchange signaling with each other and the other network functions in 5G core 620.

In some examples, the AF interface in NEF 628 receives an event UE notification generated by AS 631 from AF 629. The event UE notification indicates UE 601 is an event device. The AF interface forwards the event UE notification to the exposure module. The exposure module identifies network functions, including AMF 621, to expose the notification to. In response, the exposure module drives the AMF interface to transfer the event UE notification to the NEF interface in AMF 621.

The NEF interface in AMF 621 receives the event UE notification and delivers the notification to the event UE detection module. The event UE detection module correlates the notification to UE 601 and notifies the RAN prioritization module. For example, the event UE detection module may associate the event UE notification to the registration request or UE context for UE 601. In response to determining UE 601 is an event UE, the RAN prioritization module retrieves the KPI metrics from RANs 611-613 and determines the slice types provisioned to UE 601. For example, the RAN prioritization module may access the UE context for UE 601 stored in an Unstructured Data Storage Function (UDSF) to determine the slice IDs provisioned to UE 601. In other examples, the event UE detection module may receive the event UE notification from UE 601 over one of RANs 611-613. For example, the event UE detection module may comprise a privilege API only accessible by event UE like UE 601.

The RAN prioritization module processes the slice IDs and RAN KPIs to select one of RANs 611-613 to steer UE 601 to. For example, the prioritization module may comprise a data structure that correlates KPI scores and slice types to RAN selections. The prioritization module may use a weighted sum algorithm to generate the KPI score based on the KPI metrics retrieved for RANs 611-613. The prioritization module may then input the KPI score and slice types into the data structure that outputs a RAN selection. Alternatively, the prioritization module may comprise a machine learning engine trained to select RANs based on slice types and RAN KPIs. The prioritization module may generate feature vectors that numerically represent the provisioned slice types for UE 601 and the KPIs reported by RANs 611-613. The prioritization module may feed the feature vectors to the machine learning engine which then generates an output selecting one of RANs 611-613 to steer UE 601 to.

Once a RAN is selected, the prioritization module directs the SIB control module to steer UE 601 to the selected RAN. The SIB control module transfers instructions to RANs 611-613 to restrict which slice IDs they may broadcast in their SIBs. The control module directs the selected RAN to include all of the slice IDs provisioned to UE 601 in their SIBs. The control module directs the non-selected RANs to not include one or more of the slice IDs provisioned to UE 601 in their SIBs. RANs 611-613 receive the direction from the SIB control module and broadcast SIBs accordingly.

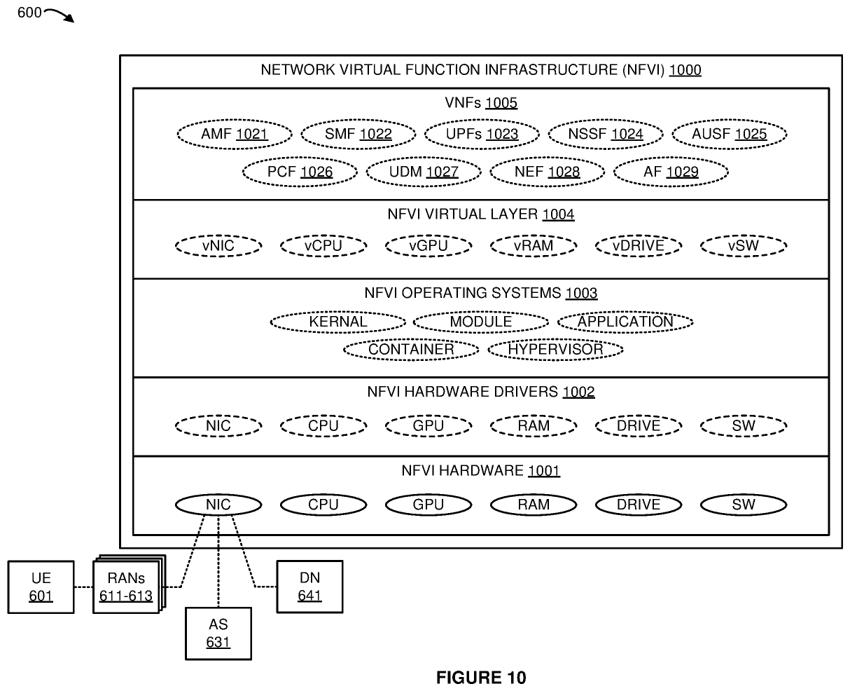

FIG. 10 illustrates Network Function Virtualization Infrastructure (NFVI) 1000 in 5G wireless communication network 600. NFVI 1000 comprises an example of core network 121 illustrated in FIG. 1 and network circuitry 320 illustrated in FIG. 3, although core network 121 and network circuitry 320 may differ. NFVI 1000 comprises NFVI hardware 1001, NFVI hardware drivers 1002, NFVI operating systems 1003, NFVI virtual layer 1004, and NFVI Virtual Network Functions (VNFs) 1005. NFVI hardware 1001 comprises Network Interface Cards (NICs), CPU, GPU, RAM, Flash/Disk Drives (DRIVE), and Data Switches (SW). NFVI hardware drivers 1002 comprise software that is resident in the NIC, CPU, GPU, RAM, DRIVE, and SW. NFVI operating systems 1003 comprise kernels, modules, applications, containers, hypervisors, and the like. NFVI virtual layer 1004 comprises vNIC, vCPU, vGPU, vRAM, vDRIVE, and vSW. NFVI VNFs 1005 comprise AMF 1021, SMF 1022, UPFs 1023, NSSF 1024, AUSF 1025, PCF 1026, UDM 1027, NEF 1028, and AF 1029. Additional VNFs and network elements like NRF, UDR, and SCP are typically present but are omitted for clarity. NFVI 1000 may be located at a single site or be distributed across multiple geographic locations. The NIC in NFVI hardware 901 is coupled to RANs 611-613, AS 631, and data network (DN) 641. NFVI hardware 901 executes NFVI hardware drivers 902, NFVI operating systems 903, NFVI virtual layer 904, and NFVI VNFs 905 to form AMF 621, SMF 622, UPFs 623, NSSF 624, AUSF 625, PCF 626, UDM 627, NEF 628, and AF 629.

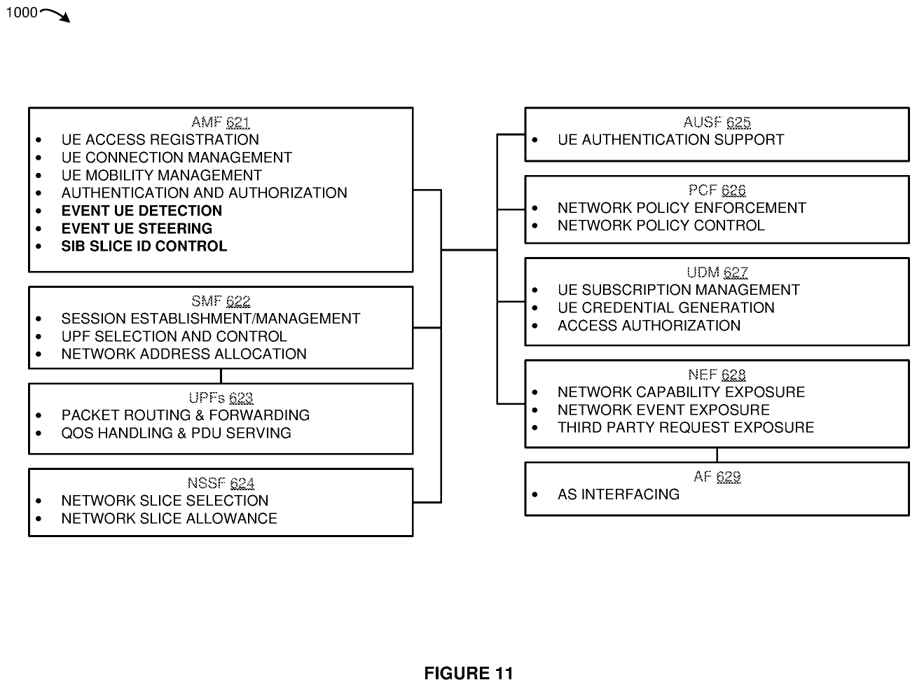

FIG. 11 further illustrates NFVI 1000 in 5G communication network 600. AMF 621 comprises capabilities for UE access registration, UE connection management, UE mobility management, UE authentication, UE authorization, event UE detection, event UE steering, and SIB slice ID control. SMF 622 comprises capabilities for session establishment, session management, UPF selection/control, and network address allocation. UPFs 623 comprise capabilities for packet routing, packet forwarding, QoS handling, and PDU serving. NSSF 624 comprises capabilities for network slice selection and network slice allowance. AUSF 625 comprises capabilities for UE authentication support. PCF 626 comprises capabilities for network policy enforcement and network policy control. UDM 627 comprises capabilities for UE subscription management, UE credential generation, and access authorization. NEF 628 comprises capabilities for network capability exposure, network event exposure, and third-party request exposure. AF 629 comprises capabilities for AS interfacing.

In some examples, AMF 621 receives a registration request for UE 601 that includes a registration type, UE capabilities, slice requests, PDU session requests, and the like. AMF 621 responds to the registration request by transferring an identity request for delivery to UE 601. AMF 621 receives an identity indication for UE 601 and selects AUSF 625 to authenticate the identity of UE 601. AUSF 625 retrieves authentication vectors and authentication challenge from UDM 627 and forwards the authentication vectors and challenge to AMF 621. AMF 621 uses the vectors to indicate the authentication type to UE 601 and transfers the authentication challenge for delivery to UE 601. AMF 621 receives an authentication response generated by UE 601 and compares the response to an expected result. AMF 621 determines the expected result and authentication response match and responsively authenticates UE 601.

Responsive to the authentication, AMF 621 selects UDM 627 to generate UE context for UE 601. AMF 621 retrieves QoS metrics, authorized slice IDs, service attributes, and the like from UDM 627. AMF 621 registers with PCF 625 to create a network policy association for UE 601. PCF 625 transfers network policy information for UE 601 to AMF 621. AMF 621 AMF 621 indicates the network slices requested by UE 601 to NSSF 624. In this example, UE 601 comprises a drone with remote operation capabilities. The slices requested by UE 601 comprise a low downlink latency command-and-control network slice and a high bandwidth live video upload network slice. Accordingly, NSSF 624 selects a low downlink latency command-and-control network slice and a high bandwidth live video upload network slice and provides the slice IDs for these slices to AMF 621. AMF 621 selects SMF 622 to serve UE 601 based on the slice IDs, QOS metrics, requested PDU sessions, and service attributes. SMF 622 identifies ones of UPFs 623 that correspond to the selected slice IDs to serve UE 601. SMF 622 indicates the network addresses for selected ones of UPFs 623. AMF 621 generates UE context comprising the information retrieved from UDM 627, the policy information provided by PCF 626, and the slice IDs returned by NSSF 624, and the UPF network addresses provided by SMF 622. AMF 621 transfers a registration approval message that comprises the UE context for delivery to UE 601 to RAN 611.

AF 629 receives an event UE request from AS 631. The request identifies UE 601 as a teleoperation event UE and requests slice-based UE steering from 5G network core 620. AF 629 forwards the request to NEF 628 which exposes the request to AMF 621. AMF 621 approves the request and transfers KPI requests for served slice IDs, RAT type, frequency/band, bandwidth, PCI, 5QI data, maximum uplink/downlink bitrate, and cell loading data to RANs 611-613. AMF 621 receives the requested metrics and determines the slice IDs that were assigned to UE 601 during registration. In this example, AMF 621 hosts a machine learning engine trained to correlate RAN KPIs and slice types to an optimal serving RAN. AMF 621 generates feature vectors that represent the slice IDs for UE 601 and the performance metrics for RANs 611-613. AMF 621 feeds the feature vectors to the machine learning engine which generates an output selecting RAN 613. Based on the output from the machine learning engine, AMF 621 directs RAN 613 to broadcast SIBs that include the slice IDs for the low downlink latency command-and-control network slice and the high bandwidth live video upload network slice. AMF 621 directs RANs 611 and 612 to not include these slice IDs in the SIBs.

Subsequently, the ones of UPFs 623 that form the command-and-control slice and live video upload slice receive uplink user data generated by UE 601 from RAN 613. These ones of UPFs 623 transfer the uplink data to data network 641 and receive downlink data for the command-and-control and live video upload services from data network 641. These ones of UPFs 623 transfer the downlink data to the downlink data for delivery to UE 601 over RAN 613.

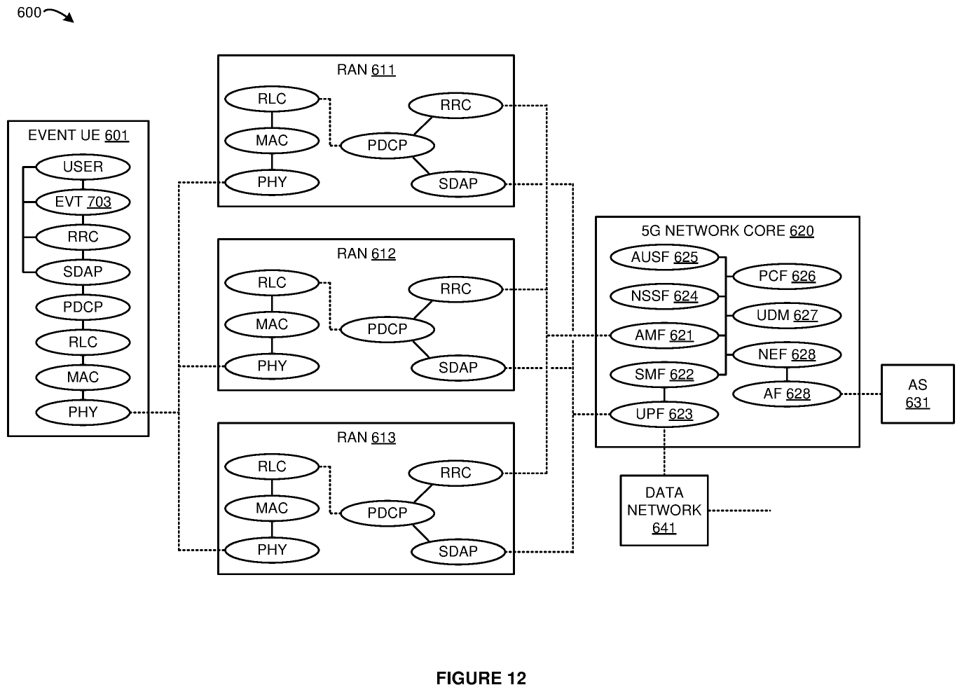

FIG. 12 illustrates an exemplary operation of 5G communication network 600 to perform slice-based steering for a 5G event UE. The operation may vary in other examples. In some examples, the RRC in UE 601 exchanges attachment signaling with the RRC in RAN 611 to wirelessly attach to RAN 611. The RRC in UE 601 generates registration request indicating registration type, UE capabilities, slice requests, and session requests. Event application 703 generates an event UE indication identifying UE 601 as an XR event UE. Event application 703 includes the indication in the registration request and the RRC in UE 601 transfers the registration request to the RRC in RAN 611 over the PDCPs, RLCs, MACs, and PHYs. The RRC in RAN 611 forwards the registration request to AMF 621. AMF 621 responds by transferring an identity request for UE 601 to the RRC in RAN 611. The RRC in RAN 611 forwards the identity request to the RRC in UE 601 over the PDCPs, RLCs, MACs, and PHYs. The RRC in UE 601 responds to the request by transferring the SUCI for UE 601 to the RRC in RAN 611 over the PDCPs, RLCs, MACs, and PHYs. The RRC in RAN 611 delivers the SUCI to AMF 621.

AMF 621 determines that authentication is required and selects AUSF 625 to authenticate the SUCI of UE 601. AMF 621 transfers SUCI to AUSF 625 which indicates the SUCI to UDM 627. UDM 627 generates authentication vectors to authenticate UE 601. UDM 627 transfers the vectors and indicates the authentication method to AUSF 625. AUSF 625 forwards the vectors and authentication method to AMF 621. AMF 621 generates an authentication challenge based on the authentication method and vectors and transfers the challenge for UE 601 to the RRC in RAN 611. The RRC in RAN 611 transfers the authentication challenge to the RRC in UE 601 over the PDCPs, RLCs, MACs, and PHYs. The RRC generates an authentication response and transfers the response to the RRC in RAN 611 over the PDCPs, RLCs, MACs, and PHYs. The RRC delivers the authentication response to AMF 621 which compares the authentication response to an expected result to authenticate UE 601.

Responsive to the authentication, AMF 621 selects UDM 627 to generate UE context for UE 601. UDM 627 accesses the subscriber profile for UE 601 and indicates service metrics from the profile to AMF 621. AMF 621 registers with PCF 625 to create a network policy association for UE 601. AMF 621 interfaces with NSSF 624 to select an XR network slice for UE 601. NSSF 624 indicates the slice ID for an XR network slice to AMF 621. AMF 621 selects SMF 622 to serve UE 601 based on the XR slice ID, QoS metrics, requested PDU sessions, service attributes, and/or other data retrieved UDM 627 or received in the registration request from UE 601. SMF 622 selects one of UPFs 623 that correspond to the slice ID to serve UE 601. SMF 622 indicates the network addresses for selected one of UPFs 623 to AMF 621. AMF 621 generates UE context comprising the information retrieved from UDM 627, the policy information provided by PCF 626, and the XR slice ID returned by NSSF 624, and the network addresses from SMF 622. AMF 621 transfers the UE context for UE 601 to the RRC in RAN 611. The RRC in RAN 611 delivers the UE context to the RRC UE 601 over the PDCPs, RLCs, MACs, and PHYs.

AMF 621 detects UE 601 is an event UE based on the indication included in the registration request by event application 703. In response, AMF 621 transfers KPI requests for served slice IDs, RAT type, frequency/band, bandwidth, PCI, 5QI data, maximum uplink/downlink bitrate, and cell loading data to the RRCs in RANs 611-613. The RRCs in RANs 611-613 access their respective KPI tables and return the requested KPI metrics to AMF 621. AMF 621 inputs the received metrics for each of RANs 611-613 and the XR slice ID into a selection algorithm. In this example, the selection algorithm indicates RAN 611 is the most optimal to serve UE 601. AMF 621 directs RAN 611 to broadcast SIBs that include the XR slice ID and prevents RANs 612 and 613 from broadcasting SIBs that include the XR slice ID. The RRC in RAN 611 broadcasts SIBs that include the XR slice ID over the PDCPs, RLCs, MACS, and PHYs. The RRCs in RANs 612 and 613 broadcast SIBs that do not include the XR slice ID over their respective PDCPs, RLCs, MACs, and PHYS.

The RRC in UE 601 wirelessly receives the SIBs broadcast by RANs 611-613 and reads the slice IDs included in the SIBs. The RRC in UE 601 detects that the SIBs broadcast by RAN 611 include the XR slice ID while the SIBs broadcast by RANs 612 and 613 do not include the XR slice ID. Consequently, the RRC decides to remain attached to RAN 611. The RRC directs the SDAP in UE 601 to begin the XR data session. The user application in UE 601 generates uplink user data for the XR session and the SDAP wirelessly transfers the uplink data to the SDAP in RAN 611. The SDAP in RAN 611 transfers the uplink user data to the one of UPFs 623 that composes the XR slice. The XR slice UPF transfers the uplink data to data network 641. Data network 641 generates downlink data for the XR session and transfers the downlink data to the XR slice UPF. The XR slice UPF transfers the downlink data to the SDAP in RAN 611. The SDAP in RAN 611 wirelessly transfers the downlink data to the SDAP in UE 601 over the PDCPs, RLCs, MACs, and PHYs.

As the session is in progress, AMF 621 requests updated KPI metrics from the RRCs in RANs 611-613 to perform mobility control for UE 601. The RRCs in RANs 611-613 access their respective KPI tables and return updated KPI metrics to AMF 621. AMF 621 inputs the updated metrics for each of RANs 611-613 and the XR slice ID into the selection algorithm. In this example, the cell loading on RAN 611 has increased and the selection algorithm outputs that RAN 613 has become the most optimal to serve UE 601. AMF 621 directs RAN 611 to remove the XR slice ID from its SIBs, prevents RAN 612 from broadcasting SIBs that include the XR slice ID, and directs RAN 613 to include the XR slice ID in its SIBs. The RRC in RAN 613 broadcasts SIBs that include the XR slice ID over the PDCPs, RLCs, MACs, and PHYs. The RRCs in RANs 611 and 612 broadcast SIBs that do not include the XR slice ID over their respective PDCPs, RLCs, MACs, and PHYs.

The RRC in UE 601 wirelessly receives the SIBs broadcast by RANs 611-613 and reads the slice IDs included in the SIBs. The RRC in UE 601 detects that the SIBs broadcast by RAN 611 no longer include the XR slice ID while the SIBs broadcast by RAN 613 include the XR slice ID. Consequently, the RRC decides to hand over to RAN 613. The RRC detaches from RAN 611 and exchanges attachment signaling with the RRC in RAN 613 over the PDCPs, RLCs, MACs, and PHYs. Once attached, the SDAP in UE 601 wirelessly transfers the uplink data to the SDAP in RAN 613. The SDAP in RAN 613 transfers the uplink user data to the one of UPFs 623 that composes the XR slice. The XR slice UPF transfers the uplink data to data network 641. Data network 641 generates downlink data for the XR session and transfers the downlink data to the XR slice UPF. The XR slice UPF transfers the downlink data to the SDAP in RAN 613. The SDAP in RAN 613 wirelessly transfers the downlink data to the SDAP in UE 601 over the PDCPs, RLCs, MACs, and PHYS.

The wireless data network circuitry described above comprises computer hardware and software that form special-purpose network circuitry to perform slice-based steering for event UE. The computer hardware comprises processing circuitry like CPUs, DSPs, GPUS, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to perform slice-based steering for event UE.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method of operating a wireless communication network to perform slice-based steering for User Equipment (UE), the method comprising:
a control plane detecting an event UE and responsively selecting a network slice to support a traffic type for the event UE;
the control plane selecting a Radio Access Network (RAN) to serve the event UE based on one or more Key Performance Indicators (KPIs) for the RAN and directing the RAN to broadcast a slice Identifier (ID) for the selected network slice;
the RAN receiving the direction from the control plane and responsively broadcasting the slice ID for the event UE;
the event UE detecting the slice ID broadcast by the RAN, matching the slice ID broadcast by the RAN to a provisioned slice ID for the event UE, and in response, wirelessly attaching to the RAN; and
the event UE wirelessly exchanging user data that comprises the traffic type over the RAN.

2. The method of claim 1 wherein the control plane selecting the RAN to serve the event UE based on the one or more KPIs comprises inputting the one or more KPIs into a data structure that correlates the one or more KPIs to an ability to support the slice type for the event UE and selecting the RAN based on an output from the data structure.

3. The method of claim 2 wherein the one or more KPIs comprise one of more of slice IDs, Radio Access Technology (RAT) type, band frequency, bandwidth, Physical Cell ID (PCI), Fifth Generation Quality-of-Service Identifier (5QI), maximum uplink bitrate, maximum downlink bitrate, and cell loading.

4. The method of claim 2 wherein the data structure comprises a machine learning algorithm trained to correlate the one or more KPIs to an ability to support the slice type for the event UE.

5. The method of claim 1 wherein the control plane detecting the event UE comprises:
an Application Server (AS) transferring an event UE request that indicates the event UE for delivery to a Network Exposure Function (NEF);
the NEF exposing the event UE request to the control plane; and
the control plane receiving the event UE request and responsively detecting the event UE.

6. The method of claim 1 wherein the control plane detecting the event UE comprises:
the event UE transferring an Application Programming Interface (API) call to a network API;
the network API receiving the API call, determining the event UE is authorized for preferred treatment; and notifying the control plane; and
the control plane receiving the notification and responsively detecting the event UE.

7. The method of claim 1 further comprising:
the RAN indicating RAN capacity data to the control plane;
the control plane receiving the indication and determining when the RAN capacity data triggers a handover threshold;
when the RAN capacity data triggers the handover threshold, the control plane selecting another RAN to serve the event UE based on one or more KPIs for the other RAN, directing the other RAN to broadcast the slice ID for the selected network slice, and directing the RAN to stop broadcasting the slice ID for the selected network slice;
the RAN removing the slice ID from its broadcast;
the other RAN broadcasting the slice ID for the event UE;
the event UE detecting the RAN is no longer broadcasting the slice ID, detecting the slice ID broadcast by the other RAN, matching the slice ID broadcast by the other RAN to the provisioned slice ID for the event UE, and in response, handing over to the other RAN; and
the event UE wirelessly exchanging user data that comprises the traffic type with the user plane over the other RAN.

8. A wireless communication network to perform slice-based steering for User Equipment (UE), the wireless communication network comprising:
a control plane to detect an event UE and responsively select a network slice to support a traffic type for the event UE;
the control plane to select a Radio Access Network (RAN) to serve the event UE based on one or more Key Performance Indicators (KPIs) for the RAN and direct the RAN to broadcast a slice Identifier (ID) for the selected network slice;
the RAN to receive the direction from the control plane and responsively broadcast the slice ID for the event UE;
the event UE to detect the slice ID broadcast by the RAN, match the slice ID broadcast by the RAN to a provisioned slice ID for the event UE, and in response, wirelessly attach to the RAN; and
the event UE to wirelessly exchange user data that comprises the traffic type over the RAN.

9. The wireless communication network of claim 8 wherein the control plane is to input the one or more KPIs into a data structure that correlates the one or more KPIs to an ability to support the slice type for the event UE and select the RAN based on an output from the data structure.

10. The wireless communication network of claim 9 wherein the one or more KPIs comprise one of more of slice IDs, Radio Access Technology (RAT) type, band frequency, bandwidth, Physical Cell ID (PCI), Fifth Generation Quality-of-Service Identifier (5QI), maximum uplink bitrate, maximum downlink bitrate, and cell loading.

11. The wireless communication network of claim 9 wherein the data structure comprises a machine learning algorithm trained to correlate the one or more KPIs to an ability to support the slice type for the event UE.

12. The wireless communication network of claim 8 further comprising:
an Application Server (AS) to transfer an event UE request that indicates the event UE for delivery to a Network Exposure Function (NEF);
the NEF to expose the event UE request to the control plane; and wherein:
the control plane is to receive the event UE request and responsively detecting the event UE.

13. The wireless communication network of claim 8 further comprising:
a network Application Programming Interface (API) to authorize devices for preferred treatment; and wherein:
the event UE is to transfer an API call to the network API;
the network API is to receive the API call, determine the event UE is authorized for preferred treatment; and notify the control plane; and
the control plane is to receive the notification and responsively detect the event UE.

14. The wireless communication network of claim 8 further comprising another RAN; and wherein:
the RAN is to indicate RAN capacity data to the control plane;
the control plane is to receive the indication and determine when the RAN capacity data triggers a handover threshold;
when the RAN capacity data triggers the handover threshold, the control plane is to select the other RAN to serve the event UE based on one or more KPIs for the other RAN, direct the other RAN to broadcast the slice ID for the selected network slice, and direct the RAN to stop broadcasting the slice ID for the selected network slice;
the RAN is to remove the slice ID from its broadcast;
the other RAN is to broadcast the slice ID for the event UE;
the event UE to detect the RAN is no longer broadcasting the slice ID, detect the slice ID broadcast by the other RAN, match the slice ID broadcast by the other RAN to the provisioned slice ID for the event UE, and in response, hand over to the other RAN; and
the event UE to wirelessly exchange user data that comprises the traffic type with the user plane over the other RAN.

15. A method of operating a wireless communication network to perform slice-based steering for User Equipment (UE), the method comprising:
an Access and Mobility Management Function (AMF) detecting an event UE and responsively selecting wireless network slices to support a traffic type for the event UE;
the AMF selecting a Radio Access Network (RAN) to serve the event UE based on Key Performance Indicators (KPIs) for the RAN and directing the RAN to broadcast System Information Blocks (SIBs) that include slice Identifiers (IDs) for the selected wireless network slices;
the RAN generating SIBs that include the slice IDs and wirelessly broadcasting the SIBs;
the event UE wirelessly receiving the SIBs broadcast by the RAN, detecting the slice IDs included in the SIBs, matching the slice IDs detected in the SIBs to provisioned slice IDs for the event UE, and in response, wirelessly attaching to the RAN; and
the event UE wirelessly exchanging user data that comprises the traffic type with a User Plane Function (UPF) over the RAN.

16. The method of claim 15 wherein the AMF selecting the RAN to serve the event UE based on the one or more KPIs comprises inputting the KPIs into a machine learning algorithm trained to correlate the KPIs to an ability to support the wireless network slices and selecting the RAN based on an output from the machine learning algorithm.

17. The method of claim 16 wherein the KPIs comprise slice IDs, Radio Access Technology (RAT) type, band frequency, bandwidth, Physical Cell ID (PCI), Fifth Generation Quality-of-Service Identifier (5QI), maximum uplink bitrate, maximum downlink bitrate, and cell loading.

18. The method of claim 15 wherein the AMF detecting the event UE comprises:
an Application Server (AS) transferring an event UE request that indicates the event UE to an Application Function (AF);
the AF forwarding the event UE request to a Network Exposure Function (NEF);
the NEF exposing the event UE request to the AMF; and
the AMF receiving the event UE request and responsively detecting the event UE.

19. The method of claim 15 wherein the AMF detecting the event UE comprises:
the event UE transferring an Application Programming Interface (API) call to a network API;
the network API receiving the API call, determining the event UE is authorized for preferred treatment; and notifying the AMF; and
the AMF receiving the notification and responsively detecting the event UE.

20. The method of claim 15 further comprising:
the RAN determining RAN capacity based on average spectrum efficiency and channel bandwidth and indicating the RAN capacity to the AMF;
the AMF comparing the RAN capacity to a bitrate requirement for the event UE and determining the when the RAN capacity falls below the bitrate requirement;
when the RAN capacity falls below the bitrate requirement, the AMF selecting another RAN to serve the event UE based KPIs for the other RAN, directing the other RAN to broadcast other SIBs that include the slice IDs for the selected wireless network slices, and directing the RAN to remove at least one of the slice IDs for the selected wireless network slices from the SIBs;
the RAN removing at least one of the slice IDs from the SIBs and broadcasting the SIBs;
the other RAN generating the other SIBs that include the slice IDs and wirelessly broadcasting the other SIBs;
the event UE receiving the SIBs broadcast by the RAN and the other SIBs broadcast by the other RAN, detecting that at least one of the slice IDs provisioned to the event UE is not included in the SIBs, matching the slice IDs detected in the other SIBs to the provisioned slice IDs for the event UE, and in response, handing over to the other RAN; and
the event UE wirelessly exchanging user data that comprises the traffic type with the UPF over the other RAN.
